(19) United States
(12) Patent Application Publication
(10) Pub. No.: US 2026/0023012 A1
(43) Pub. Date: Jan. 22, 2026

(54) ISOTOPE RATIO MEASURING DEVICE USING ISOTOPE NOTCH FILTER

(71) Applicant: KOREA ATOMIC ENERGY RESEARCH INSTITUTE, Daejeon (KR)

(72) Inventors: Byung-Jae CHUN, Daejeon (KR); Do-Young JEONG, Daejeon (KR); Hyoun-Min PARK, Daejeon (KR); Kwang-Hoon KO, Seoul (KR); Taek-Soo KIM, Daejeon (KR); Lim LEE, Daejeon (KR); Yong-Hee KIM, Daejeon (KR)

(21) Appl. No.: 18/993,655

(22) PCT Filed: Jul. 12, 2023
(86) PCT No.: PCT/KR2023/009949

§ 371 Date: Jan. 13, 2025

(30) Foreign Application Priority Data
Jul. 14, 2022 (KR) 10-2022-0087070

(51) Int. Cl. G01N 21/25; G01N 21/31; G01N 21/3518

(52) U.S. Cl. CPC G01N 21/255; G01N 21/314; G01N 21/3518; G01N 2021/3181; G01N 2021/3188

(57) ABSTRACT

The present invention may be applied to a measuring device capable of measuring a concentration ratio between carbon isotopes in carbon dioxide. One embodiment of the present invention comprises: a light source unit; a sample gas cell which is positioned on an optical path irradiated from the light source unit; a gas cell band-pass filter unit which is positioned on the optical path which has passed through the sample gas cell, and is provided with a first band-pass filter and a second band-pass filter, the first band-pass filter having formed therein a sealed space in which a gas containing a first isotope is present, and the second band-pass filter having formed therein a sealed space in which a gas containing a second isotope, which is a different isotope of the same element as that of the first isotope, is present; and a light receiving unit.

### TECHNICAL FIELD

The present disclosure relates to a band-pass filter using a gas cell filled with a specific gas, and more particularly, to a gas cell based on one of carbon isotopes of carbon dioxide. This may be applied to a measuring device that can measure a concentration ratio between carbon isotopes in carbon dioxide.

### BACKGROUND ART

A CO₂-based respiratory diagnostic method diagnoses the presence or absence of a disease by measuring a change in a concentration ratio of ¹³CO₂ and ¹²CO₂ in breath generated after artificially administering a ¹³C-based marker into a human body. Currently, the method commonly used to measure the concentration ratio of ¹³CO₂ and ¹²CO₂ is a light absorption-based spectroscopic system, which separates a wide emission wavelength of a broadband light source into an absorption spectrum region of ¹³CO₂ and ¹²CO₂, an amount of light absorption of individual isotopes is measured, to measure the relative concentration ratio.

As the conventional method, a multilayer thin film-type band-pass filter is used, to separate an absorption spectrum band of each isotope from a wide spectrum emitted from a broadband light source. When light corresponding to the absorption spectrum of ¹²CO₂ and ¹³CO₂ having passed through each band-pass filter passes through a gas to be measured, such as breath, or the like, the energy of the corresponding spectrum is adsorbed by the gas through interaction gas. A change in the relative concentration of ¹³CO₂ and ¹²CO₂ is observed using a change in light intensity reaching a light receiving unit thereafter.

For CO₂, there is a strong absorption spectrum in the 4.1 to 4.6 μm wavelength band in a mid-infrared region. In the case of a multilayer thin film-type band-pass filter, a thin film with a thickness of λ/4 should be repeatedly stacked and coated. However, the mid-infrared region has a longer wavelength than wavelengths that optical systems such as visible light, near-infrared, and the like, frequently use, so the thickness of the thin film is thick, making uniform coating difficult. Accordingly, there may be a problem that it is difficult to process the main specifications of the processed band-pass filter such as a center wavelength and a bandwidth, with consistent quality.

In the case of the currently commercially available multilayer thin film-type band-pass filters, a center wavelength in the 4 μm band as described above has a tolerance of about 100 nm, and a bandwidth has a tolerance of about 40 nm, making it difficult to manufacture a precise band-pass filter in the desired region. In addition, there is a problem that, in the region in which the absorption spectra of ¹³CO₂ and ¹²CO₂ overlap each other, it is impossible to selectively and perfectly distinguish each wavelength region using existing filters. This limits the region of the absorption spectrum of carbon dioxide available for spectroscopic measurements, ultimately resulting in a decrease in signal-to-noise ratio. Therefore, the development of a band-pass filter that can solve this problem is required.

(Patent Document 1) Korean Patent No. 10-0436320 (Jun. 7, 2004)

### SUMMARY OF INVENTION

### Technical Problem

The present disclosure is intended to solve the above-described problems, and is to provide a device for measuring a concentration ratio of isotopes by using a gas cell in which a specific gas is injected with high purity as a band-pass filter for wavelength extraction.

### Solution to Problem

In order to achieve the above-described purposes, an aspect of the present disclosure is to provide an isotope concentration ratio measuring device using a gas cell band-pass filter as follows.

According to an aspect of the present disclosure, provided is an isotope ratio measuring device, the isotope ratio measuring device including: light source unit including one or more light sources; a sample gas cell positioned on an optical path of light irradiated from the light source unit, and having a gas inlet and a gas outlet; a gas cell band-pass filter unit positioned on the optical path of light having passed through the sample gas cell, and having a first band-pass filter and a second band-pass filter, the first band-pass filter having a sealed space in which a gas containing a first isotope is present, formed therein, and the second band-pass filter having a sealed space in which a gas containing a second isotope, which is a different isotope of the same element as the first isotope, is present, formed therein; and a light receiving unit provided on the optical path of light having passed through the gas cell band-pass filter, and measuring an amount of light entering, as an electrical signal. The first isotope is ¹³C and the second isotope is ¹²C.

### Advantageous Effects of Invention

As set forth above, in the present disclosure, through an isotope ratio measuring device including a gas cell band-pass filter as described above, a precise band-pass filter may be configured at a desired wavelength using a gas's unique absorption spectrum, and even in a region in which absorption spectra of isotopes overlap, only a wavelength of a specific isotope contained in the gas cell may be effectively extracted.

In the present disclosure, using the isotope ratio measuring device described above, a ratio of carbon isotopes for respiratory diagnosis may be precisely and efficiently measured.

### BRIEF DESCRIPTION OF DRAWINGS

FIG. 1 is a drawing illustrating an isotope ratio measuring device according to an embodiment of the present disclosure.

FIG. 2 is a perspective view of a band-pass filter included in an isotope ratio measuring device according to an embodiment of the present disclosure.

FIG. 3 is a cross-sectional view of a band-pass filter included in an isotope ratio measuring device according to an embodiment of the present disclosure.

FIG. 4 is a graph of an absorption line of an isotope of CO₂ in a wavelength range of 2200 to 2600 cm⁻¹.

FIG. 5 is a graph of an absorption line of an isotope of CO₂ in a wavelength range near 2300 cm⁻¹.

### MODE FOR INVENTION

Hereinafter, specific embodiments of the present disclosure will be described with reference to the accompanying drawings. However, the idea of the present disclosure is not limited to the presented embodiments, and those skilled in the art who understand the idea of the present disclosure will be able to easily propose other regressive disclosures or other embodiments included within the scope of the idea of the present disclosure by adding, changing, or deleting other components within the scope of the same idea, but this will also be considered to be included within the scope of the idea of the present disclosure.

In addition, components having the same function within the same scope of the same idea shown in the drawings of each embodiment are described using the same reference numerals.

It is common to use a multilayer thin film-type band-pass filter to separate absorption spectrum bands of each isotope from a wide spectrum emitted from a broadband light source.

For most gases, a wavelength with strong absorption spectrum is a mid-infrared region in which ro-vibrational modes are present. For example, CO₂ has an absorption spectrum in a 4.1-4.6 μm region.

In the case of the mid-infrared region, the wavelength is longer than the wavelengths widely used in an optical system, such as visible light and near-infrared light, and due to this characteristic, a thickness of a thin film in the multilayer thin film-type band-pass filter is thick, making it difficult to coat uniformly. Therefore, there is a problem that it is difficult to process with consistent quality.

In addition, due to the quality problems in the mid-infrared region, a multilayer thin film-type band-pass filter with a relatively large tolerance is used. When the wavelength band of an isotope is intended to be separated using a broadband light source, a region in which the absorption spectra overlap each other is formed due to the characteristics of the isotope, and an absorption region of the isotope is formed in a relatively narrow range compared to the tolerance described above, so it is possible to perfectly distinguish respective wavelength regions in the region in which the absorption spectra overlap.

In particular, in the case of carbon dioxide, the absorption spectrum of CO₂, which includes carbon isotopes ¹²C and ¹³C, is formed with a narrow interval therebetween of several hundred MHZ (˜pm), making separation impossible using a conventional multilayer thin film-type band-pass filter. To avoid this problem, only absorption spectra with non-overlapping regions have been used for measurement.

To solve such problems, an isotope ratio measuring device 100 including a gas cell-based band-pass filter 1 is intended to be provided, which expands the absorption spectrum region used for measurement in a broadband wavelength range and can expect an improvement in the signal-to-noise ratio by also using overlapping regions for measurement.

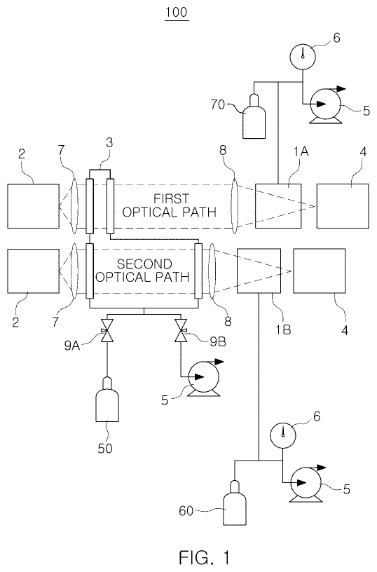

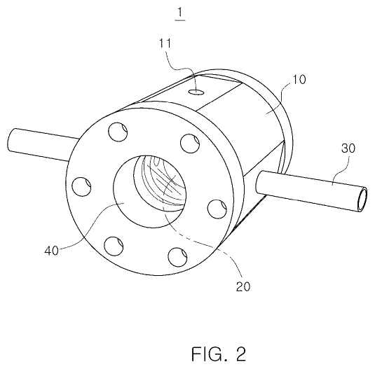

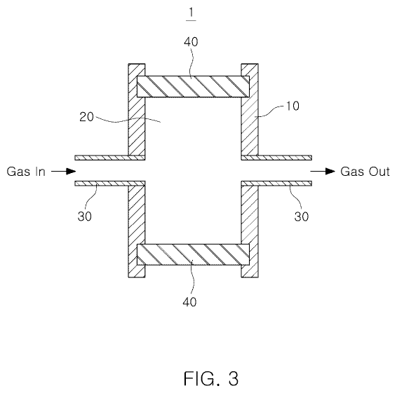

FIG. 1 illustrates a schematic configuration of an isotope ratio measuring device according to an embodiment of the present disclosure. FIG. 2 illustrates a perspective view of a gas cell-based band-pass filter included in an isotope ratio measuring device according to an embodiment of the present disclosure, and FIG. 3 illustrates a cross-sectional view thereof.

According to an aspect of the present disclosure, an isotope ratio measuring device includes a light source unit 2 including one or more light sources; a sample gas cell 3 positioned on an optical path of light irradiated from the light source unit 2, and having a gas inlet and a gas outlet and into which a sample gas is injected; a gas cell band-pass filter unit positioned on the optical path of light having passed through the sample gas cell 3, and having a first band-pass filter (1A) and a second band-pass filter (1B), the first band-pass filter (1A) having a sealed space in which a gas containing a first isotope is present, formed therein, and the second band-pass filter (1B) having a sealed space in which a gas containing a second isotope, which is a different isotope of the same element as the first isotope, is present, formed therein; and a light receiving unit 4 provided on the optical path of light having passed through the gas cell band-pass filter unit, and measuring an amount of light entering, as an electrical signal.

In the present disclosure, in order to compare relative numbers of isotopes contained in a sample gas, an optical path may be set as the number of isotopes to be measured. As an example, a case having two optical paths will be described.

The light source unit 2 includes all light sources for emitting light in a region absorbed by a sample gas, and a broadband light source such as an LED may be used.

As an example, two light sources are provided according to the number of isotopes, respectively. However, measurements may also be performed by distributing one light source using an optical device such as a diffraction grating, a light splitter, or the like.

Hereinafter, a sample gas cell 3, a gas cell band-pass filter unit, and a light receiving unit 4 are positioned according to a path of light irradiated from the light source unit 2.

Light irradiated from the light source unit 2 passes through a first optical lens 7. The light irradiated from the light source unit 2 may be adjusted to parallel light through the first optical lens 7. The light having passed through the first optical lens 7 is directed to the sample gas cell 3.

The sample gas cell 3 is a cell into which a gas to be measured is injected. A gas inlet and a gas outlet are provided, respectively, and a sample gas to be measured is introduced.

The gas inlet is configured to inject a sample gas into the sample gas cell 3, and the gas outlet is configured to discharge a gas after measurement to the outside of the cell. If the inlet and outlet are provided together as described above, continuous measurement of the gas to be measured may be performed.

The form of the sample gas cell 3 may be an L-shape in which there is a difference in a length ratio according to the intensity of the absorption spectrum of the isotope to be measured, but the shape of the sample gas cell 3 is not limited thereto.

Light having passed through the first optical lens 7 is introduced into the cell through a first window formed in the sample gas cell 3 and a specific wavelength is absorbed by the sample gas. The absorbed wavelength varies depending on the component contained in the sample gas.

Light of a specific wavelength absorbed passes through the second window of the sample gas cell to the outside of the sample gas cell 3.

The light having passed through the sample gas cell 3 is refracted again through the second optical lens 8, and is focused on one point. The focused light is directed to a gas cell band-pass filter unit having a band-pass filter 1.

The gas cell band-pass filter unit is configured to include multiple band-pass filters 1, the gas cell band-pass filter unit including a first band-pass filter (1A) and one or more second band-pass filters (1B).

As an embodiment of the present disclosure, for the purpose of measuring a ratio of isotopes contained in a sample gas, optical paths are formed as many as the number of isotopes of which the ratios are to be measured. As an example, a case of having two optical paths is provided. However, the number of optical paths may be set to be greater than that.

The first band-pass filter (1A) includes a case 10 forming a sealed space 20.

At least a portion of the case 10 is formed to be transparent, and an optical window 40 through which light passes is formed through this portion. That is, the optical window 40 through which light passes may be formed transparently so that the light may pass through the first band-pass filter (1A).

The optical window 40 may be formed by the case being drawn inwardly, and a position of the optical window 40 in the sealed space 20 may also be formed symmetrically.

The case 10 may be formed in a cylindrical shape. When the case 10 is formed in a cylindrical shape, it is effective in easily establishing a vacuum environment. However, the shape thereof is not limited to a specific shape.

The inside of the case 10 contains a gas containing an isotope. The optical path passing through the first band-pass filter (1A) is called a first optical path. A ratio of the second isotope in the sample gas is measured through the first optical path.

Therefore, the gas contained in the first band-pass filter (1A) contains a first isotope, which is the same element as the second isotope but is a different isotope from the second isotope. The gas containing the first isotope, which is an internal gas of the case 10, should be contained with high purity.

That is, a gas comprised of a second isotope may also be included, but the number of gases comprised of the first isotope should be greater than the number of gases comprised of the second isotope.

The second band-pass filter (1B) includes a case 10 forming another sealed space 20.

An optical path passing through the second band-pass filter (1B) may be called a second optical path.

As with the first band-pass filter (1A), at least of the case 10 is formed to be transparent or the case 10 has an optical window 40 formed so that light may optically pass therethrough formed therein. The second optical path is irradiated from the light source unit 2 and passes through the optical window 40 of the second band-pass filter (1B).

That is, the optical window 40 is formed in a portion introduced from the case 10 along the second optical path and in a portion through which the introduced light passes, so that the light may pass the second band-pass filter (1B).

The case 10 may be configured in a cylindrical shape, and when formed in a vacuum, the case 10 has an effect of easily establishing a vacuum environment. However, the shape of the case 10 is not limited to a specific shape.

The inside of the case 10 contains a gas containing an isotope. The second band-pass filter (1B) contains a second isotope, which is different from the first isotope contained in the first band-pass filter (1A). A gas containing the second isotope should be contained, with high purity, in the sealed space 20 of the second band-pass filter (1B).

That is, the gas containing the first isotope may also be included, but the number of gases containing the second isotope should be greater than the number of gases containing the first isotope.

As configured as above, the ratio of the first isotope contained in the sample gas may be measured through the second optical path.

Therefore, in the first optical path and the second optical path, light passes through the first band-pass filter (1A) and the second band-pass filter (1B), containing different isotopes with high purity, respectively.

The case 10 of the first band-pass filter (1A) and the second band-pass filter (1B) may further include a port 30 formed on one side thereof. An amount of gas injected into the sealed space 20 through the port 30 may also be controlled.

If a physical composition of the gas present in the closed space 20 is the same, when the amount of gas is adjusted, the size of the closed space 20 is constant, so the pressure of the gas changes.

In this case, since the form of the absorption spectrum absorbed by the gas introduced thereinto changes, the filtering intensity and the filtering bandwidth may be controlled. In addition, by controlling the temperature of the gas cell, the central wavelength of the absorption spectrum may be shifted by changing the temperature of the internal gas. This has the effect that can be used as a tunable optical filter with the ability to change the filtering intensity, bandwidth, and center wavelength.

In order to be used as an optical filter for shifting the filtering intensity, bandwidth, and center wavelength as described above, the first band-pass filter (1A) may further include a gas container 70 containing the first isotope, a pump 5, and a vacuum gauge 6, and the second band-pass filter (1B) may further include a gas container 60 containing the second isotope, a pump 5, and a vacuum gauge 6. The first band-pass filter (1A) and the second band-pass filter (1B) may further include a control valve for opening and closing the sealed space 20 therein.

The case 10 of the first band-pass filter (1A) and the second band-pass filter (1B) further includes a coupling member 11 to control a position according to the first optical path or the second optical path. The position may be directly changed and fixed through the coupling member 11, or a structure for position control may be coupled.

An amount of light entering through the light receiving unit 4 located on a path of light having passed through the gas cell band-pass filter unit may be measured as an electrical signal.

A change in the amount of light received from the light receiving unit 4 may be derived as an electrical signal. For example, it can be recognized as a voltage difference.

A measurement value obtained by injecting a reference gas into the sample gas cell 3 may be used as a reference. Thereafter, the gas to be measured may be injected into the sample gas cell 3 and then measured, and the change can be identified by a value obtained from the light receiving unit 4.

As an embodiment of the present disclosure, a control unit (not shown) may be further included for calculating a ratio of the first isotope and the second isotope using the measurement value measured by the light receiving unit 4.

Since the first band-pass filter (1A) and the second band-pass filter (1B) contain different isotopes, the ratio of the isotopes may be calculated by comparing a first measurement value, which is a measurement value of the light receiving portion 4 having passed through the first band-pass filter (1A), with a second measurement value, which is a measurement value of the light receiving portion 4 having passed through the second band-pass filter (1B).

Since the number of second band-pass filters (1B) may be changed according to the number of isotopes, even when two or more isotopes are present, measurement may be performed using the isotope ratio measuring device 100 according to an embodiment of the present disclosure.

As an example of the present disclosure, a reflector (not shown) may be further included to control an optical path. When the optical path is formed to be long or short, the degree of absorption by the gas is different, so the reflector may be further included and formed.

In addition, a sample gas cell 3 located in the isotope ratio measuring device 100 of the present invention should have a vacuum environment established inside before a measurement gas to be measured is introduced. Thereby, measurement errors, due to air, or the like, are prevented.

A sample gas container 50 may be configured to be connected to the sample gas cell 3. In this case, the inside of the sample gas cell 3 may be made into a vacuum environment through a pump 5 connected through a pipe, and then it may be injected.

In addition, control valves 9A and 9B for opening and closing a gas inlet or a gas outlet are also included. The control valves 9A and 9B may be located on the gas inlet or gas outlet of the sample gas cell 3.

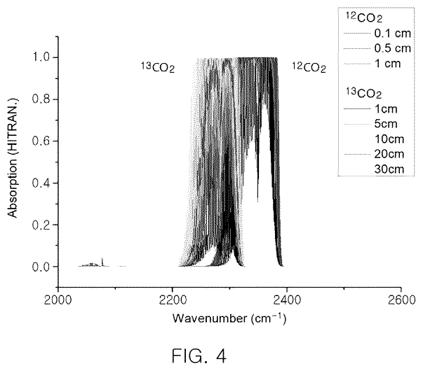

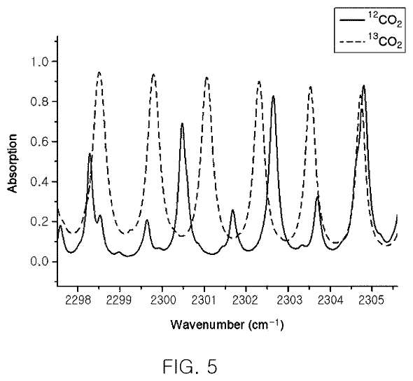

FIGS. 4 and 5 illustrate an absorption line for a wavelength of carbon dioxide. The absorption line of each of ¹²CO₂ and ¹³CO₂ are shown. FIG. 4 illustrates a wavelength range from 2000 to 2600 cm⁻¹, and FIG. 5 is a graph illustrating a wavelength range around 2300 cm⁻¹ in detail.

As an example, when an isotope to be measured is C, a gas containing the isotope may be CO₂, and a first isotope of the gas contained in the first band-pass filter (1A) and the second band-pass filter (1B) may be ¹³C and a second isotope thereof may be ¹²C.

The existing multilayer thin film-based optical band-pass filter selects and distinguishes a specific wavelength range, selects a region having the absorption spectrum of ¹²CO₂ and ¹³CO₂, and calculates the isotope ratio through a change in light intensity in that region.

In order to distinguish wavelength ranges for measuring ¹²CO₂ and ¹³CO₂ in absorption spectroscopy-based respiratory diagnosis for diagnosing a disease by using the difference in the concentration of ₁₂CO₂ and ¹³CO₂ in breath, a gas cell band-pass filter unit according to an embodiment of the present disclosure uses the difference in wavelength bands in which the absorption spectra of ¹²CO₂ and ¹³CO₂ are located, and calculates an isotope ratio based on the change in light intensity due to a CO₂ gas in each wavelength band.

In a mid-infrared region in which a ro-vibrational mode of CO₂ is present, absorption spectra are present in a 2300-2400 cm⁻¹ region for ¹²CO₂ and in a 2200-2300 cm⁻¹ region for ¹³CO₂.

A first optical path may be a path for measuring ₁₂CO² containing a second isotope. A first band-pass filter (1A) in which the number of ¹³CO₂ containing the first isotope, ¹³C, is greater than the number of ¹²CO₂, is provided along the first optical path.

By having the first band-pass filter (1A) as described above, ¹³CO₂ is included in the first band-pass filter (1A) with high purity, in the first optical path, so that ¹³CO₂ acts as a notch filter at a wavelength in which ¹³CO₂ forms an absorption line in the first band-pass filter (1A).

Therefore, a wavelength component absorbed by ¹³CO₂, which is adjacent to the absorption line of ¹²CO₂ to be measured, may be removed, and as a result thereof, only an amount of light attenuated by the absorption spectrum of ¹²CO₂ may be measured. This reduces an error of the measurement value due to the absorption spectrum of adjacent ¹³CO₂ during measurement, and allows more accurate measurement of only the amount of light attenuated by interaction with ¹²CO₂.

The second optical path may be a path for measuring ¹³CO₂ containing the first isotope. Along the second optical path, a second band-pass filter (1B), in which the number of ¹²CO₂ containing the second isotope, ¹²C, is greater than the number of ¹³CO₂.

By having the second band-pass filter (1B) as described above, ¹²CO₂ is included in the second band-pass filter (1B) with high purity, in the second optical path, so that ¹²CO₂ acts as a notch filter at a wavelength in which ¹²CO₂ forms an absorption line in the second band-pass filter (1B).

Therefore, a wavelength component absorbed by ¹²CO₂, which is adjacent to the absorption line of ¹³CO₂ to be measured, may be removed, and as a result thereof, only an amount of light attenuated by the absorption spectrum of ¹³CO₂ may be measured, so that only the amount of light attenuated by interaction with ¹³CO₂ may be measured more accurately.

Therefore, the measuring device 100 according to an example of the present disclosure has improved isotope ratio measurement sensitivity.

According to FIG. 4, it can be seen that ¹²CO₂ and ¹³CO₂ have different degrees of absorption depending on the length of a path in which ¹²CO₂ and ¹³CO₂ pass through.

By using the characteristics, the degree of absorption may be changed by changing the optical path formed in the first band-pass filter (1A) or the second band-pass filter (1B). That is, the optical path may be changed by controlling the optical configuration or by controlling the size of a physical sealed space 20 formed in the first band-pass filter (1A) or the second band-pass filter (1B).

In particular, in the case in which the light source formed in the light source unit 2 is a broadband light source such as an LED light source, there is a problem that it is difficult to use for measurement event though it is a wavelength range in which a high amount of light is output form a commonly used LED light source, since absorption lines of ¹²CO₂ and ¹³CO₂ overlap in the 2300 cm⁻¹ region.

According to FIG. 5, the absorption spectrum of ¹²CO₂ and ¹³CO₂ overlap each other in adjacent regions, but when the absorption lines are expanded, it can be seen that individual absorption spectra may be separated.

By using this, a band-pass filter 1 as in an embodiment of the present disclosure may extract only the necessary region of a densely packed absorption spectrum, thereby providing the effect of allowing a greater amount of light to be used for measurement.

The problem of overlapping isotope absorption lines in the mid-infrared region as described above may be solved by using the isotope ratio measuring device 100 including a gas cell band-pass filter unit as in an embodiment of the present disclosure. In addition, these characteristics are not limited to measurements of isotope ratios of carbon isotopes.

For example, the isotope detection system according to an embodiment of the present disclosure may be used to detect leakage of heavy water during reactor operation using not only carbon dioxide (CO₂) but also hydrogen isotopes of water (H₂O).

Although the present disclosure has been described in detail through examples above, other types of examples are also possible. Therefore, the technical spirit and scope of the claims set forth below are not limited by the embodiments.

### Description of Reference Numerals

1: Band-pass filter
1A: First band-pass filter
1B: Second band-pass filter
2: Light source unit
3: Sample gas cell
4: Light receiving unit
5: Pump
6: Vacuum gauge
7: First optical lens
8: Second optical lens
9A, 9B: Control valve
10: Case
20: Sealed space
30: Port
40: Optical Window
100: Isotope Ratio Measuring Device

1. An isotope ratio measuring device, comprising:
a light source unit including one or more light sources;
a sample gas cell positioned on an optical path of light irradiated from the light source unit, and having a gas inlet and a gas outlet;
a gas cell band-pass filter unit positioned on the optical path of light having passed through the sample gas cell, and having a first band-pass filter and a second band-pass filter, the first band-pass filter having a sealed space in which a gas containing a first isotope is present, formed therein, and the second band-pass filter having a sealed space in which a gas containing a second isotope, which is a different isotope of the same element as the first isotope, is present, formed therein; and
a light receiving unit provided on the optical path of light having passed through the gas cell band-pass filter unit, and measuring, as an electrical signal, an amount of light entering.

2. The isotope ratio measuring device of claim 1, wherein the first band-pass filter and the second band-pass filter further comprise,
a case forming a sealed space,
wherein the case further includes an optical window through which light is able to pass on the optical path.

3. The isotope ratio measuring device of claim 1, wherein the gas cell band-pass filter unit has a gas containing an isotope to be measured therein,
the gas contained in the first band-pass filter is configured such that the number of gases containing the first isotope is greater than the number of gases containing the second isotope, and
the gas contained in the second band-pass filter is configured such that the number of gases containing the second isotope is greater than the number of gases containing the first isotope.

4. The isotope ratio measuring device of claim 3, wherein the gas containing the isotope is CO₂, and the first isotope is ¹³C, and the second isotope is ¹²C.

5. The isotope ratio measuring device of claim 3, further comprising:
a control unit in which a ratio of the first isotope and the second isotope is calculated using a measurement value, measured from the light receiving unit.

6. The isotope ratio measuring device of claim 2, wherein the case is formed in a cylindrical shape, and
the case includes a port formed on one side of the case, and an amount of the gas is controlled through the port.

7. The isotope ratio measuring device of claim 1, wherein the light source unit includes an LED light source.
